(19) United States
(12) Patent Application Publication
(10) Pub. No.: US 2010/0280902 A1
(43) Pub. Date: Nov. 4, 2010

(54) SYSTEM AND METHOD FOR CREATING SOCIAL SERVICES BASED ON BUYING EXPERIENCE

(76) Inventor: Wei Pang, Shanghai (CN)

Correspondence Address: SCHWEGMAN, LUNDBERG & WOESSNER/EBAY, P.O. BOX 2938, MINNEAPOLIS, MN, 55402, US

(21) Appl. No.: 12/088,043

(22) PCT Filed: Dec. 7, 2007
(86) PCT No.: PCT/CN07/03485

§ 371 Date: Mar. 25, 2008

(51) Int. Cl. G06Q 30/00

(52) U.S. Cl. 705/14.54; 705/14.53; 705/14.66; 705/14.4

(57) ABSTRACT

A computer-implemented system and method for creating social services based on buying experience in a networked system are disclosed. A system embodiment includes an interface to receive merchandising information from a plurality of sources, the merchandising information being related to a plurality of buyers; and a social recommendation engine to process the merchandising information to identify related buyers, and to notify a user of a related buyer based on the merchandising information.

### BACKGROUND

1. Technical Field

This disclosure relates to networked systems. More particularly, the present disclosure relates to creating social services based on buying experience in a networked system.

2. Related Art

Current systems provided several ways for users to create and use online social/professional networks. For example, U.S. Pat. No. 7,085,806 describes a method and apparatus for locating and recommending a match to another. The apparatus provides people with a way to take an active role in matchmaking between a friend, family member or client of theirs and a prospect date from a database of prospect-users. For example, users may be provided with the ability to review a repository of users who have registered with a dating service (referred to as prospect-users) in order to search for a person who may be compatible with a friend or associate of the user performing the search (referred to as a searching-user). If the searching-user locates a prospect-user whom the searching-user thinks may be of interest to the searching-user's friend or associate (referred to as a client-user), the searching-user may recommend that person to the prospect-user. Thus, the apparatus provides a way to transmit a recommendation message to the prospect-user via a communication conduit such as a computer network.

United States Patent Application No. 2006/0129551 describes a system providing leisure and entertainment attraction information from commercial attraction-provider servers. Users subscribe to a computerized service to facilitate making arrangements for visiting such attractions. Subscribers fill in wish-lists to specify their level of interest in specific attractions, in getting together with specific other subscribers, and in arranging their preferred schedules for outings. An encounter generator processes the subscriber wish-lists to identify matches of subscribers who are interested in the same attraction, who favor each other's company, and who are free at the same time. The system notifies the matched subscribers, optionally offering ticketing and/or reservation assistance. The system is adaptable for serving singles who wish to identify and get to know a prospective mate through mutual visits to attractions, as well as individuals, couples, and families who want to go out with their existing friends or make new friends.

United States Patent Application No. 20050273378 describes a system where electronic commerce over a publicly accessible computer network such as the Internet is facilitated and leveraged by a computer system that forms a community of computer user parties based on personal and business connections of the parties involved. Personal connections are created between users by invitation and mutual acceptance. Business connections are created between users when a transaction takes place between those users. Users search to perform any one or more of a variety of actions such as to purchase products, browse departments and categories for purchasing products, or explore the connections between the parties involved to find items to buy. Different groupings of the parties involved may be the users themselves and other buyers/sellers in the business network, the users themselves and their friends in the personal networks, or some combination of buyers/sellers and friends from each of the types of networks. A computer or server at a site in the network implements an architecture whereby various pages viewed by a user have links to enable them to find products.

United States Patent Application No. 20050272413 describes a system where a business or social networking method is operative in a server. The method enables mobile device users to meet one another, on a permission basis. The determination of whether a given pair of mobile device users are introduced depends on whether the server determines they are in intellectual or “cognitive” proximity, which is typically a function of one or more factors, such as: each user's reciprocal networking objective, the nature of the industry in which the user works, the user's level within the management hierarchy of his or her company, any specialty function the individual may possess, and so on. Individuals who are matched in one or more of such attributes to a given degree or threshold are said to be in intellectual proximity. According to the invention, when given mobile devices users are within physical proximity of one another during an overlapping time window, the server determines whether the users are also within a given intellectual proximity. If so, and if both users have opted to receive new introductions, the server issues a mutual collaboration opportunity message to each of the mobile device users to determine whether they desire to be introduced to one another. Preferably, the mutual collaboration opportunity message masks personally identifying information. If the mobile device users agree to be introduced, the server establishes a direct private messaging session between them. In an alternative embodiment, a mobile device user initiates a contact by performing a networking search query that identifies one or more prospects who can then be contacted by the mobile device user asynchronously.

United States Patent Application No. 20040153514 describes a system for providing an ally of a profile within a computer network and for organizing, building, and propagating the computer network by building a reference hierarchy through an ally association system or function. Through the ally association system or function, allies of a subject featured in a profile supported in the computer network can perform one or more association-related functions, such as vouching or witnessing for the subject, referring or introducing the subject to another, and other similar functions for one or more purposes. The ally association function facilitates network growth, provides more efficient network operations, optimizes the purpose of the network, provides more organization to the network, and brings to a computer network or online environment many of the associations and interactions and other similar interpersonal dealings common and popular in real space, while at the same time functioning to propagate the number of users in the network via the propagation of allies associated with the subjects featured in the network profiles. Several business models utilizing the ally association technology provide users and allies alike various incentive to obtain and utilize the ally association technology, which in turn helps to build a more vibrant, active, and interwoven community and increase the revenue potential from operation of the network.

United States Patent Application No. 20020178072 describes a system and method for providing a social experience coupled to a virtual shopping mall which creates an apparent geographical coupling between cyberstores within the virtual mall and shoppers within the mall. An online mall shopper may configure a list of other shopping “buddies”. The online shopping mall system then notifies or otherwise alerts the shopper of the presence of other concurrently online shoppers from the buddy list, allows for the shoppers to communicate and move to each other's present position within the shopping mall. When both shoppers are at the same virtual position within the shopping mall, they are presented with the same product information or virtual mall images and sounds, such that they may communicate with each other about a product or store in the mall. Shoppers may find other “buddy” shoppers by proximity, common interest terms, and may introduce shoppers to each other to build group conversations.

However, current systems do not provide a means for aggregating a collection of buyer behaviors or transaction histories to provide recommendations for potential friends in a social networking context.

Thus, a computer-implemented system and method for creating social services based on buying experience in a networked system is needed.

### BRIEF DESCRIPTION OF THE DRAWINGS

Embodiments illustrated by way of example and not limitation in the figures of the accompanying drawings, in which:

FIG. 1 illustrates an example embodiment of a networked system in which various embodiments may operate

FIG. 2 is a processing flow diagram of an example embodiment.

FIG. 3 shows a diagrammatic representation of a machine in the form of a computer system within which a set of instructions, for causing the machine to perform any one or more of the methodologies discussed herein, may be executed, according to an example embodiment.

### DETAILED DESCRIPTION

A computer-implemented system and method for creating social services based on buying experience in a networked system are disclosed. In the following description, numerous specific details are set forth. However, it is understood that embodiments may be practiced without these specific details. In other instances, well-known processes, structures and techniques have not been shown in detail in order not to obscure the clarity of this description.

As described further below, according to various example embodiments of the disclosed subject matter described and claimed herein, there is provided a computer-implemented system and method for creating social services based on buying experience in a networked system. Various embodiments are described below in connection with the figures provided herein.

### Overview of Various Embodiments

In a particular example embodiment, a social recommendation engine can provide individualized social services to a buyer based on the buyer's previous purchasing behavior or experience. These social services can include recommending the buyer to an associated group of other like buyers with a similar purchasing behavior or experience. The purchasing behavior or experience can include the buyer's history of purchase transactions, search queries, website interactions, or other buyer behavior that can be tracked and retained by a host website. For example, a particular buyer may have previously purchased, bid on, or searched for various items of tennis-related products on a host website. The host website can use this information to identify the buyer as being interested in products or services related to a category of sporting equipment and a subcategory of tennis equipment. The host website can further associate the buyer with groups of other buyers who have also made purchases from, or bid on, or searched for items in a category of sporting equipment and a subcategory of tennis equipment. Once the buyer has been associated with these other groups of buyers with similar purchasing behavior or experience, the host site can recommend the buyer to the other groups of buyers in a social context or the host site can invite the buyer to become a member of the other groups of buyers.

In a particular example embodiment, the social recommendation functionality is implemented in a set of processing modules. In the example embodiment, these modules include: Main Pages, Merchandising, Buyer Groups, Suggest Buyer Group, Search Buyer Groups, Join Buyer Group. Each of these modules are described in the sections of this document below.

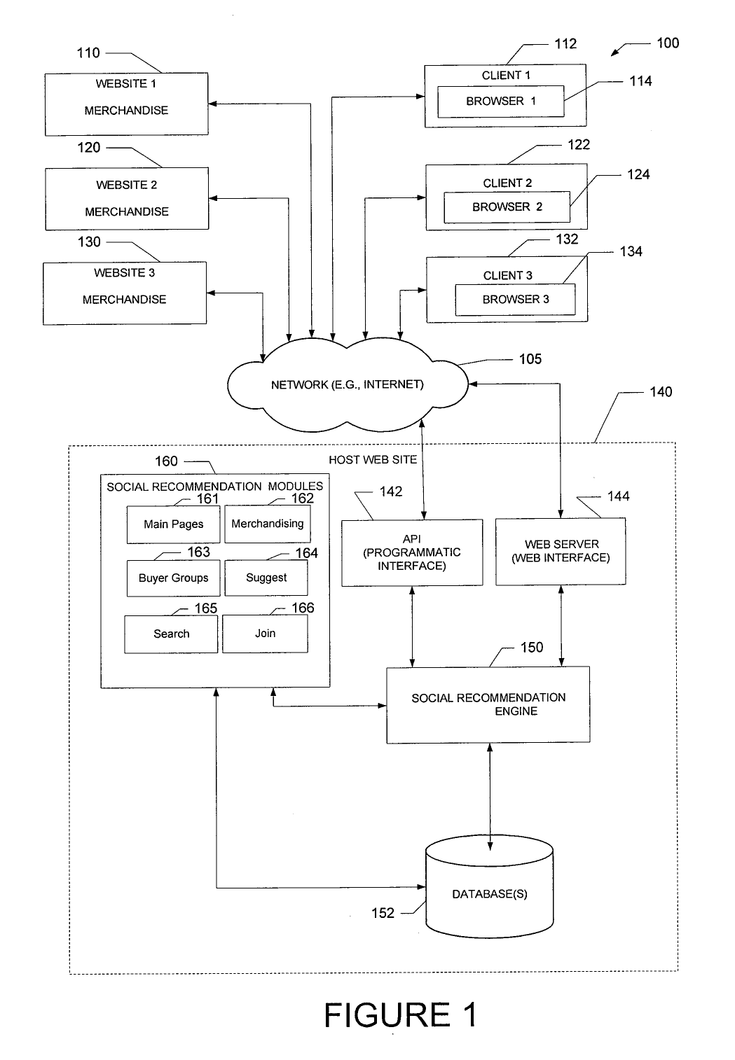

Referring to FIG. 1, an example networked system 100 in which various embodiments may operate is illustrated. As shown, various users of client systems 112, 122, and 132 using browsers 114, 124, and 134 can communicate with and interact with various websites 110, 120, and 130 via a network 105, such as the Internet. Using well known protocols (e.g. HTTP) and user interfaces, users can perform commercial transactions (e.g. purchase/lease products and services, bid on products/services, perform product searches, etc.) on various websites, such as websites 110, 120, and 130. The commercial transaction history created and/or maintained by users or websites can be in a variety of forms. Transaction logs, search queries, shopping carts, user profiles, webpage interactions and interactions with other information sources related to people, products/services, vendors and the like are also created and maintained on the websites 110, 120, 130, or client systems 112, 122, and 132. Unfortunately, these information sources are typically independent, disparate, and unconnected. Particular embodiments described herein seek to gather information content in various forms that relate to a given buyer or buyer group and form social connections wherein users interested in the given category or subcategory of products or services may communicate with other interested users to form social connections in an efficient and easy manner.

Referring still to FIG. 1, a host website 140 may host the social recommendation functionality of various embodiments. A social recommendation engine 150 provides a control mechanism to receive user requests via web server interface 144 or application programming interface (API) 142. As described in more detail below, such requests may be received in the form of a link provided on a web page of the host website 140. Activation of the link by a user of client systems 112, 122, and 132 causes activation of the social recommendation engine 150 by the host website 140.

Depending upon the particular request issued by the user to the social recommendation engine 150, the social recommendation engine 150 can employ one of the social recommendation modules 160 to service the request. For example, a user activation of a social recommendation link may cause the display of a set of main pages (described in more detail below) as provided by main pages module 161. Similarly, a user activation of a social recommendation link may cause the display of a set of merchandising information, transaction history information, product category information, and/or the like as provided by merchandising module 162. Further, a user activation of a social recommendation link may cause the display of a set of buyer group pages (described in more detail below) as provided by buyer groups module 163. Each of the other social recommendation modules 160 may also service particular social recommendation requests made by a user. As described in more detail below, merchandising module 162 provides merchandising content associated with a particular user/buyer or a particular buyer group. As explained above, each user/buyer can be associated with a particular set of merchandising information, including commercial transaction histories, further including commercial transaction logs, search queries, shopping carts, user profiles, webpage interactions, credit/debit usage, commercial memberships, frequent flyer memberships, interactions with other information sources related to people, products/services, vendors and the like. Any merchandising information associated with a particular user/buyer is aggregated by merchandising module 162 and served upon request to an authorized user. For example, a particular user/buyer may have a history of purchasing tennis equipment from one or more merchants associated with websites 110, 120, or 130. Merchandising module 162 may then aggregate and process merchandising information from websites 110, 120, or 130 and use this information to identify the user/buyer as being interested in products or services related to a category of sporting equipment and a subcategory of tennis equipment. Buyer Groups module 163 can further associate the user/buyer with groups of other buyers who have also made purchases from, or bid on, or searched for items in a category of sporting equipment and a subcategory of tennis equipment. Once the user/buyer has been associated with these other groups of buyers with similar purchasing behavior or experience, the Suggest module 164 can suggest the user/buyer to the other groups of buyers in a social context or the Join module 166 may be used to invite the user/buyer to join one of the other groups of buyers. The join module 166 provides the social recommendation functionality for joining a group of buyers. The search module 165 provides the functionality to search merchandising data and/or buyer groups as stored in database 152.

### Social Recommendation Main Pages Module

This section describes the functionality of an example embodiment of the Social Recommendation Main Page as provided by main pages module 161. Each buyer group can have its own main page for the host site with which the social recommendation engine 150 is associated. The main page provides links or user interface buttons that enable a user to display and/or activate the social recommendation functions described above.

### Merchandising Module

Merchandising module 162 provides merchandising content associated with a particular user/buyer or a particular buyer group. As explained above, each user/buyer can be associated with a particular set of merchandising information, including commercial transaction histories, further including commercial transaction logs, search queries, shopping carts, user profiles, webpage interactions, credit/debit usage, commercial memberships, frequent flyer memberships, interactions with other information sources related to people, products/services, vendors and the like. Any merchandising information associated with a particular user/buyer is aggregated by merchandising module 162 and served upon request to an authorized user. For example, a particular user/buyer may have a history of purchasing tennis equipment from one or more merchants associated with websites 110, 120, or 130. Merchandising module 162 may then aggregate and process merchandising information from websites 110, 120, or 130 and use this information to identify the user/buyer as being interested in products or services related to a category of sporting equipment and a subcategory of tennis equipment.

The merchandising module can access the user/buyer merchandising information by making application programming interface (API) calls to, for example websites 110, 120, and 130.

### Buyer Group Module

Buyer Groups module 163 processes the merchandising information associated with a particular user/buyer or a particular buyer group. Buyer Groups module 163 can associate the user/buyer with groups of other buyers who have also made purchases from, or bid on, or searched for items in a related merchandise category or subcategory. As explained above, each user/buyer can be associated with a particular set of merchandising information, including commercial transaction histories, further including commercial transaction logs, search queries, shopping carts, user profiles, webpage interactions, credit/debit usage, commercial memberships, frequent flyer memberships, interactions with other information sources related to people. This information is used to group buyers with like purchasing behaviors or experiences into buyer groups. Each buyer group can represent one or more individual users/buyers with similar purchasing histories or buying experiences. Each buyer group can be given a name or identifier. A user activation of a social recommendation link may cause the display of a set of buyer group pages as provided by buyer groups module 163.

### Join Module

The join module 166 displays the names of the buyer groups as retrieved from the database 152. The join module 166 also retrieves the number of users who have joined the particular buyer group from the database. Display of the membership count can be configurable and defaulted to not display.

The join module 166 also provides the functionality to enable users to join a buyer group. The join module 166 can be used to display a join buyer group widget on the social recommendation main page. In a particular embodiment, there can be three hyperlinks on the Join buyer group widget as specified below.

### Join This Buyer Group

### Invite a Friend

### Tell Me About This Buyer Group

Display Properties for all signed in and joined members of this buyer group can also be displayed. In a particular embodiment, there can be a dropdown list displaying all the names of the buyer groups the user has joined. The current buyer group name can be the selected item in the drop down list. The items in the drop down list can be arranged alphabetically. The user can select any of the buyer groups on the dropdown list and can be redirected to the page of the selected buyer group.

If the user is signed in and in good standing (confirmed registered user and not suspended) and they click the Join button, they can be automatically joined to the buyer group and can remain on the current page. If the user is not registered/signed in and clicks the Join button, the user can be taken to the registration/sign-in page and on successful registration/sign-in can be automatically joined to the buyer group (if possible—otherwise the user may need to click Join again after having signed in). The user can be automatically brought back to the buyer group page. On successfully joining a buyer group, the Join button can be replaced with a view of the joined buyer group. If there is an error during the join process, a plain text message should display “Sony we couldn't join you to the buyer group now.” in the area normally occupied by the Join button. A user should still be able to join a buyer group if they have Javascript turned off.

On click of the Invite a friend link, a pop-up form can be displayed if the user is signed in. If the user is not signed in/registered and clicks the Invite a friend link, the user can be re-directed to sign-in/register flow and after registration/signing in the user can be brought back to the same social recommendation main page, and the pop-up form can be automatically displayed. The pop-up for “Invite a friend” can be displayed as a layer on top of the existing social recommendation main page. The form can contain fields to enter the friend's email address and a welcome message. The form format can be similar to the ‘Email to a friend’ format. There can be a pre-populated welcome message that can be edited by the user. The maximum size for the welcome message is 4000 characters (no HTML, JS, asterisks or quotes allowed). The actual email sent by the form can contain additional text that is not displayed on the form. The email can contain a link that can bring the friend to the social recommendation page from which the email was generated. The default picture for the buyer group can be displayed in the email along with additional text. There can be a pre-populated subject line for the email. The subject cannot be edited by the user. There can be a TO field where the user can enter only one email address at a time. A maximum of 50 characters is allowed. There can be a disclaimer—‘host site won't use this address for promotional purposes, or disclose it to a third party’. The mail can display the user's registered email ID in the FROM field. There can be a check for the email address format (*@*.*). There can be a Send Message Button that when clicked can perform error checks on the form, and if passed successfully, can send the email and close the form. Any submission errors can be displayed in-line in the form. There can be a Cancel Button, which can close the pop-up form and not send the email. The user can remain on the social recommendation page after submission or cancellation and the pop-up can close. There can be a provision for turning off the Invite a friend feature (Partner Contingency). If the user has javascript turned off, they can not be able to use this feature. There can be a limit of 10 email invites sent per user per social recommendation per day.

On mouse over of the ‘Tell Me About This Buyer Group (aka Help) link and icon, a small pop-up window can be displayed showing some text describing the Buyer Group. Also, a More link can be displayed. On clicking the More link or the Help link, the user can be taken to the social recommendation Help pages in the Help section of the site.

### Search Module

This section describes the functionality of an example embodiment of the Search Module 165 and the Results page produced thereby. The Search Results page can take as input a query string up to 60 characters in length. A text input box allowing for 60 characters of input can be displayed and pre-populated with the query passed in. A Search button submits the query in the text box to the Search module 165 back end and refreshes the social recommendation Search Results page. If a query is passed in to the page, the results for the associated query can display. The search can do a case insensitive query against the merchandising data and/or related buyer group names and their associated keywords for the current site. Social recommendation buyer group names and keywords can be indexed “as is” from the Social recommendation data model. No query language or qualifiers can be used in the query string. The search back-end can first attempt to find exact matches for the query. Common articles such as “a”, “an”, “the” can be ignored using the functionality already found in the search back-end. If no exact matches are found, then the back-end can spell correct the query keywords and attempt an exact match again. In this case, the page should display the following message with the “I” icon—“We couldn't find a match for your search so we tried <spell corrected term>”. The spell corrected term should also replace the original query term in the title bar. After searching for the exact matches, the back-end can attempt to find partial matches using an OR search. If there are still no matches, then the message ‘Your search for <query> returned zero results.” should display and the back-end should also show a Suggest a Buyer Group link and display alternate search terms for the query keywords. Each of the alternate search terms can be a link to the Social recommendation Search Results page for the term. A Browse All Buyer Groups link should also appear. If there is an error fetching results, the following message should display “There was an error fetching the matching buyer groups.” The total number of results found can be displayed. Results can be paginated and up to 25 results can displayed on a single page. Each result returned can be the display name of the buyer group (linked to its associated buyer group page), its default picture (48×36 size) and also show the current number of members in the buyer group, and the current number of posts in the buyer group's discussion board (if possible). The display name may contain non-ASCII characters such as Chinese or accented characters. The link however, must be ASCII characters valid for URLs. Within each group, the results are ordered by the largest number of members first. The user can be able to change the sorting options via a Sort By drop down. Selecting a new sort can re-order the results. The options are Exact Match, Membership (largest number of members first), Activity (largest number of discussion board posts first), Popularity (largest number of page views), and Alphabetical. Using sorting options other than Exact Match can result in a list of results where partial and exact matches are mixed together.

### Suggest Module

The Suggest Module 164 can be used to inform or notify users that others users have similar purchasing histories or experiences and thus create social connections. On click of the ‘Suggest a Buyer Group link’ as provided by the suggest module 164, if the user is signed in, a pop-up form can be displayed. On click of the Suggest a Buyer Group link, if the user is not signed in/registered, the user can be re-directed to the sign in/registration page. After registration/signing in the user can be brought back to the same social recommendation page, and the pop-up form can be automatically displayed. The pop-up can be displayed as a layer on top of the existing social recommendation page. In a particular embodiment, the ‘Suggest a Buyer Group form can contain four fields (input type: plain text only, no HTML, JS, asterisks or quotes allowed) as specified below.
Buyer Group Name (maximum 100 characters)
Short Description of Buyer Group (maximum 500 characters)
Key words describing the Buyer Group (5 keywords, each of maximum 50 characters)
Why is this social recommendation important to you? (maximum 500 characters)

The maximum characters allowed can be displayed for each field. The number of characters remaining can be displayed for the Buyer Group Name, Short Description and the text field for ‘why is this social recommendation important to you?’ as the user types into the text fields. The ‘Buyer Group’ and ‘Short Description’ fields are required; ‘Key words describing the Buyer Group and ‘why is this social recommendation important to you’ fields are optional. The form should have a (*) next to the Buyer Group Name and Short Description fields to indicate they are required. There can be a SUBMIT and CANCEL button. When the user clicks SUBMIT, the form can check if all the required fields are populated. If some required fields are unpopulated, then an inline error message can be displayed in the form, ‘Error message text’. If the form is submitted successfully, the data can be saved in the database The form can close and the user can remain on the social recommendation page. If there is an error saving the data, an error message can be displayed in the form, ‘Error message text’. If the user clicks the CANCEL button, the form can close and no suggestion can be sent to host site. The submitted data can be stored along with the user's userid, site id, the Buyer Group id (if present), the date and time of submission, and the user's email address (if possible). There can be a provision for turning off the Suggest a Buyer Group function (Partner Contingency). If a user has JS turned off, they cannot use this feature. A user should not be able to send more than a total of 50 ‘Suggest a Buyer Group messages (total across all sites) in a given 24 hour period.

### APIs

Various embodiments include an application programming interface (API) for retrieving merchandising information and buyer group information. GetUser and GetUserProfile calls can be modified to return the complete list of Buyer Groups that the requested user has joined. After a user has finished paying for an item and is on the last page of the new checkout flow, related Buyer Group content can be displayed. Each suggested buyer group can display the name of the buyer group as a link to the buyer group and may display the number of members and the 50 pixel size of the default picture for each buyer group if so configured.

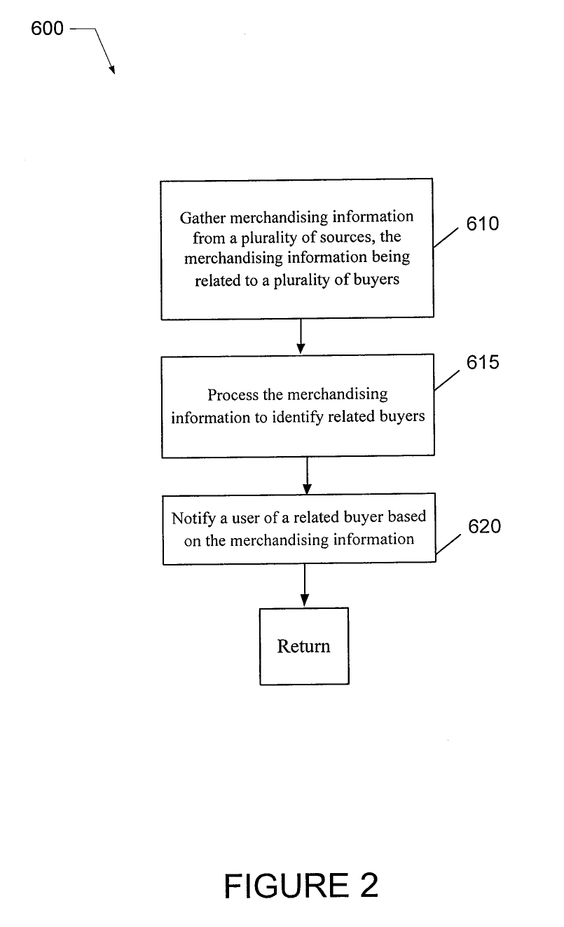

FIG. 2 is a processing flow diagram of an example embodiment. In the example embodiment, a method includes gathering merchandising information from a plurality of sources, the merchandising information being related to a plurality of buyers (processing block 610), processing the merchandising information to identify related buyers (processing block 615), and notifying a user of a related buyer based on the merchandising information (processing block 620). The method may include an implementation wherein buyer groups are created from the related buyers.

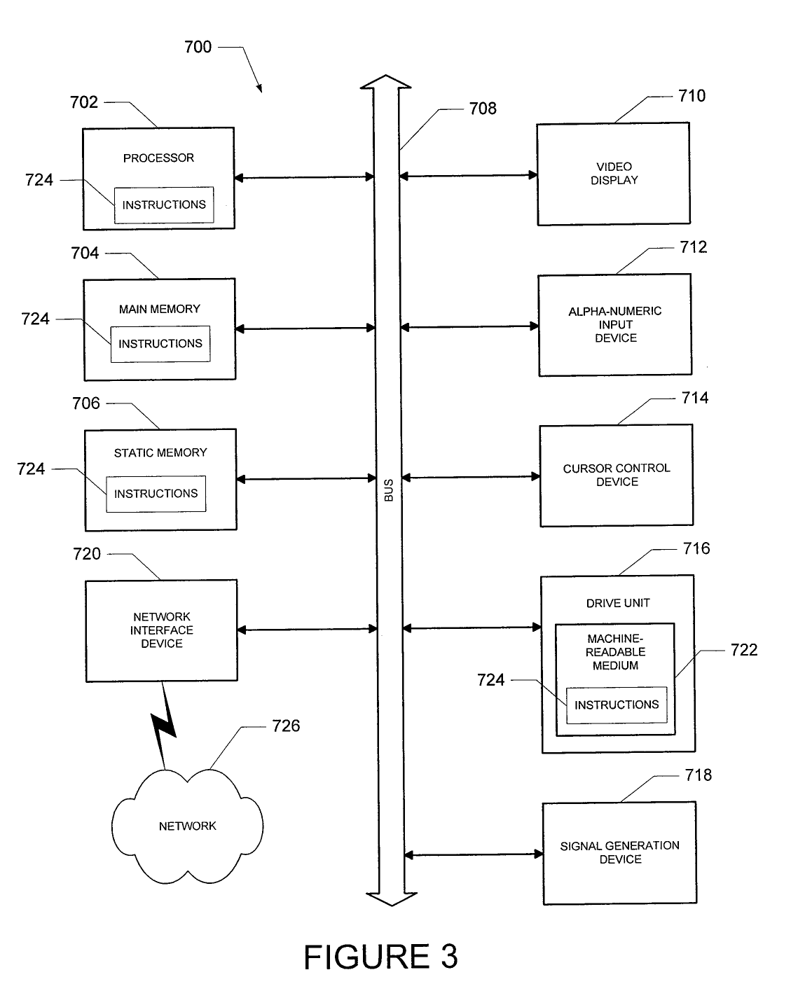

FIG. 3 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented system and method for creating social services based on buying experience in a networked system are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A method comprising:
gathering merchandising information from a plurality of sources, the merchandising information being related to a plurality of buyers;
processing the merchandising information to identify related buyers; and
notifying a user of a related buyer based on the merchandising information.

2. The method as claimed in claim 1 including creating buyer groups are created from the related buyers.

3. The method as claimed in claim 1 wherein the merchandising information includes commercial transaction history.

4. The method as claimed in claim 1 wherein the merchandising information includes user profiles.

5. The method as claimed in claim 1 wherein the merchandising information includes product category and subcategory information.

6. The method as claimed in claim 1 wherein the merchandising information includes user search queries.

7. The method as claimed in claim 1 including enabling a buyer to search a buyer group.

8. The method as claimed in claim 1 including enabling a buyer to join a buyer group.

9. A system comprising:
an interface to receive merchandising information from a plurality of sources, the merchandising information being related to a plurality of buyers; and
a social recommendation engine to process the merchandising information to identify related buyers, and to notify a user of a related buyer based on the merchandising information.

10. The system as claimed in claim 9 wherein the social recommendation engine being further configured to create buyer groups from the related buyers based on the merchandising information.

11. The system as claimed in claim 9 wherein the merchandising information includes commercial transaction history.

12. The system as claimed in claim 9 wherein the merchandising information includes user profiles.

13. The system as claimed in claim 9 wherein the merchandising information includes product category and subcategory information.

14. The system as claimed in claim 9 wherein the merchandising information includes user search queries.

15. The system as claimed in claim 9 wherein the social recommendation engine being further configured to enable a buyer to search a buyer group.

16. The system as claimed in claim 9 wherein the social recommendation engine being further configured to enable a buyer to join a buyer group.

17. An article of manufacture comprising a machine-readable storage medium having machine executable instructions embedded thereon, which when executed by a machine, cause the machine to:
receive merchandising information from a plurality of sources, the merchandising information being related to a plurality of buyers; and
process the merchandising information to identify related buyers, and to notify a user of a related buyer based on the merchandising information.

18. The article of manufacture as claimed in claim 17 being further configured to create buyer groups from the related buyers based on the merchandising information.

19. The article of manufacture as claimed in claim 17 wherein the merchandising information includes commercial transaction history.

20. The article of manufacture as claimed in claim 17 wherein the merchandising information includes user profiles.

21. The article of manufacture as claimed in claim 17 wherein the merchandising information includes product category and subcategory information.

22. The article of manufacture as claimed in claim 17 wherein the merchandising information includes user search queries.

23. The article of manufacture as claimed in claim 17 being further configured to enable a buyer to search a buyer group.

24. The article of manufacture as claimed in claim 17 being further configured to enable a buyer to join a buyer group.
